(19) United States
(12) Patent Application Publication
(10) Pub. No.: US 2026/0238272 A1
(43) Pub. Date: Aug. 13, 2026

(54) MOBILE DISTRIBUTED MIMO FOR ENHANCED PERFORMANCE AND DEPLOYMENT FLEXIBILITY

(71) Applicant: VIRGINIA TECH INTELLECTUAL PROPERTIES, INC., Blacksburg, VA (US)

(72) Inventors: Lingjia Liu, Alexandria, VA (US); Nishithkumar Tripathi, Parker, TX (US); Jeffrey H. Reed, Blacksburg, VA (US); Daniel Jakubisin, Blacksburg, VA (US); Yang Yi, Blacksburg, VA (US); R. Michael Buehrer, Christiansburg, VA (US); Karim Said, Blacksburg, VA (US); Yibin Liang, Blacksburg, VA (US); Charlie Thornton, Blacksburg, VA (US); Usama Saeed, Blacksburg, VA (US); Kumar Sai Bondada, Blacksburg, VA (US); Ramin Safavinejad, Blacksburg, VA (US); Evan Allen, Blacksburg, VA (US); Nima Mohammadi, Blacksburg, VA (US); Hanchao Yang, Blacksburg, VA (US); Ummay Sumaya Khan, Blacksburg, VA (US); Tom Anders, Blacksburg, VA (US)

(21) Appl. No.: 19/540,526

(22) Filed: Feb. 13, 2026

Related U.S. Application Data
(60) Provisional application No. 63/758,194, filed on Feb. 13, 2025.

(51) Int. Cl. H04B 7/06

(52) U.S. Cl. CPC H04B 7/0617

(57) ABSTRACT

A communication system of the present disclosure comprises a base station node and a plurality of assisting mobile nodes, wherein the plurality of assisting mobile nodes are in wireless communications with the base station node. Accordingly, in a downlink transmission of data from the base station node to a user equipment device, the base station node is configured to transmit data to the plurality of assisting mobile nodes, the base station node and the plurality of assisting nodes are configured to perform precoding signal processing on the data, and the base station node and the plurality of assisting nodes are configured to transmit the precoded data to the user equipment device.

### CROSS-REFERENCE TO RELATED APPLICATION

This application claims priority to co-pending U.S. provisional application entitled, “Mobile Distributed MIMO for Enhanced Performance and Deployment Flexibility,” having application No. 63/758,194, filed Feb. 13, 2025, which is entirely incorporated herein by reference.

### STATEMENT REGARDING FEDERALLY SPONSORED RESEARCH OR DEVELOPMENT

This invention was made with Government Support under Grant No. W900KK2390031 awarded by the Department of Defense. The Government has certain rights in the invention.

### BACKGROUND

In Distributed MIMO (Multiple-Input Multiple-Output) (D-MIMO) systems, a group of distributed antennas using different radios is spread out in a geographic area to cooperate and form a large virtual antenna array, aiming to achieve capacity and reliability gains promised by MIMO while circumventing the form factor constraints of individual base stations (BSs). In the typical formulation, these radio units (RUs) are connected to a single central signal processing unit (CPU) through a high-speed front-haul (FH), utilizing dedicated, expensive coaxial or fiber optic cables. Research has shown promising gains from an information-theoretic point of view, as well as improvements in coverage and range extension with uniform quality of service (QoS). However, the challenges of this system include increased complexity and significant signaling overhead (due to a greater number of RF chains) and necessitating extensive infrastructure deployments (requiring physical space for antenna deployment with the high-capacity FH links, including the cost of real estate rental and high installation time). This demands substantial network optimization to determine the placement of these static radios, resulting in escalated capital and operating expenditures.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a wireless distributed multiple-input multiple-output (D-MIMO) architecture in accordance with various embodiments of the present disclosure.

FIG. 1B shows an exemplary mobile distributed MIMO (MD-MIMO) architecture in accordance with various embodiments of the present disclosure.

FIG. 2 illustrates cluster-to-cluster communications using MD-MIMO architecture in accordance with various embodiments of the present disclosure.

FIG. 3 depicts average minimum, median, and maximum rates of nodes in an initial phase (Phase 1) of an exemplary D-MIMO operation in accordance with various embodiments of the present disclosure.

FIGS. 4A-4B depict the average capacity and relative capacity increase over a baseline in a second phase (Phase 2) of an exemplary D-MIMO operation in accordance with various embodiments of the present disclosure.

FIG. 5 depicts the average capacity versus the D-MIMO node transmission power level during a second phase (Phase 2) of an exemplary D-MIMO operation in accordance with various embodiments of the present disclosure.

FIG. 6 shows a timing diagram for an exemplary D-MIMO operation in accordance with various embodiments of the present disclosure.

FIGS. 7A-7B depict D-MIMO capacity compared to a baseline under Urban Micro (UMi) path-loss settings in accordance with various embodiments of the present disclosure.

FIG. 8 shows a schematic block diagram of a computing system or device that can be used to implement various embodiments of the present disclosure.

### DETAILED DESCRIPTION

Distributed MIMO (Multiple-Input Multiple-Output) (D-MIMO) antenna systems have been adopted in 5G NR standards in the form of multiple Transmission and Reception Point (mTRP) architecture where distributed antenna elements/radio units are connected to a 5G radio base station (gNB) through fiber optics. The present disclosure presents a further extension of the MIMO technology under the D-MIMO infrastructure. Accordingly, the present disclosures provides systems and methods that replace the fiber connections linking distributed antenna elements/radio units and the base station with wireless links to realize mobile distributed MIMO (MD-MIMO) antenna systems in next/future generation wireless networks (NextG/FutureG).

In the most general sense, D-MIMO operation refers to a range of techniques that involve the cooperation of multiple radio nodes to assist in the conveyance of information originating from a single source node to a single destination node. The main advantage of distributed MIMO over collocated MIMO is that it overcomes the form-factor constraints of a single terminal. Size limitations of a terminal limit the antenna spacing, which increases the channel correlation between antennas and in turn reduces the capacity gains. To obtain independent channel realizations across antennas, the spacing must be least one wavelength in length which can be both spatially and economically prohibitive for sub-6 GHz frequencies. Furthermore, the unconstrained geographical distribution of nodes comprising a D-MIMO system provides macro diversity against large scale effects such as fades and shadowing by increasing the probability of line-of-sight (LOS) paths to receiving nodes.

In a D-MIMO setup, a high-speed connection known as the front-haul (FH) links the source node to its assisting nodes. The high-speed FH link is typically realized using a wired link such as an optical fiber which can carry a high-speed stream of I/Q (in-phase and quadrature) samples between the main source node and the assisting nodes. This offers the advantage of offloading all baseband processing from the assisting nodes to the main source node. For coherent transmission, phase, timing, and frequency level synchronization is required across all nodes. Achieving this level of synchronization incurs additional overhead signaling over the FH link.

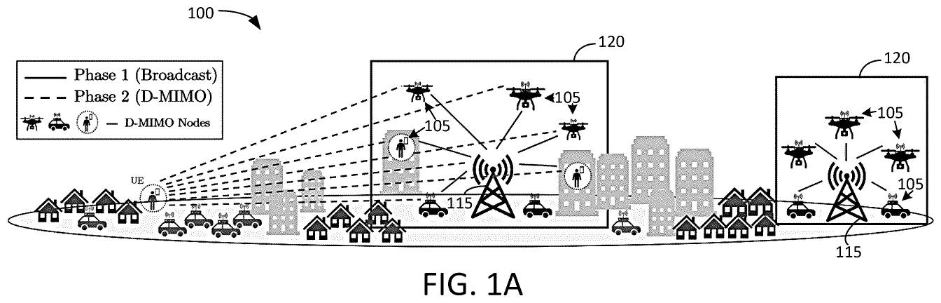

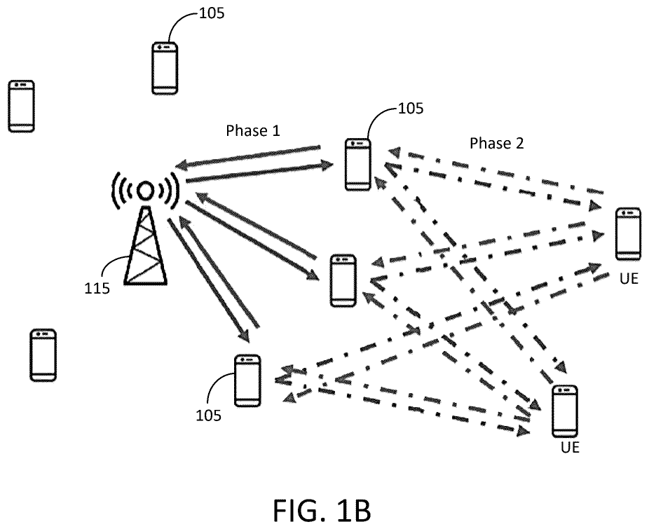

Both wired and wireless D-MIMO systems require substantial modifications to current network architectures by distributing assisting nodes throughout an entire cell and connecting them to the main source node via wired or wireless FH links. Correspondingly, as shown in FIG. 1A, the present disclosure provides an architecture where the user equipment on the network 100 are wireless mobile nodes (D-MIMO nodes, which act as transceivers with multiple antennas) 105 that participate in joint distributed MIMO transmission with a base station (BS) 115 that takes on the role of the main source node. Accordingly, systems and methods of the present disclosure differ from previously proposed D-MIMO systems, as the BS 115 takes on the responsibilities of the main source node while also jointly transmitting with the assisting D-MIMO nodes (radio units) 105. In other words, the radio units (RUs) on the BS 115 and the RUs of the D-MIMO 105 nodes jointly transmit together, with precoding signal processing occurring at each entity. An exemplary architecture of the present disclosure operates in two phases: an initial communication phase (Phase 1) between the BS 115 and D-MIMO nodes 105 to forward data for joint transmission, i.e., front-haul, followed by a D-MIMO phase (Phase 2) where the BS 115 and D-MIMO nodes 105 jointly transmit to user equipment (UEs). Unlike existing D-MIMO work, in various embodiments, both phases share the same frequency band since the D-MIMO nodes 105 are users on the network. Thus, the initial transmission phase is a cost (loss of channel resources) that can be accounted for in the capacity analysis. To minimize this cost, the D-MIMO nodes 105 can be selected such that the initial phase is a high-capacity link between the BS 115 and D-MIMO nodes 105, e.g., closer to the BS 115.

In various embodiments, D-MIMO nodes 105 may include 3GPP-oriented unmanned aerial vehicles (UAVs), vehicular UEs, and handset UEs (e.g., mobile phones). The nodes can be either opportunistically selected or dedicated. For instance, vehicular or handset UEs can be opportunistically chosen, or the BS 115 can signal to UAV drones for optimized placement. Moreover, in accordance with various embodiments, the D-MIMO nodes 105 are not restricted to a single BS; they can be capable of functioning with any BS 115. Accordingly, D-MIMO nodes 105 can be deployed on-demand in areas where the network load on the BS 115 is high and the BS 115 alone is insufficient to support UEs in the geographic area or support the users who are in a complete blackout region due to low SNR (signal-to-noise ratio) links from the BS 115. Since the D-MIMO nodes 105 are wirelessly connected to the BS 115, this reduces infrastructure costs associated with deploying fiber networks, provides the required deployment flexibility with optimized placement, and offers the scalability to increase or decrease the number of nodes as needed to scale up or down the antennas.

Further, since the architecture incurs signaling overhead, the nodes 105 are active in D-MIMO operation only when needed. In various embodiments, the D-MIMO nodes 105 can streamline data processing, focusing solely on the physical layer for D-MIMO operation, bypassing the 5G RAN protocol stack processing (i.e., Radio Resource Control/Service Data Adaptation Protocol to Medium Access Control layers). The exemplary architecture also ensures integration with current cellular systems and reuse of existing deployments, thereby optimizing resource utilization. Such architecture holds the potential to be deployed in diverse environments such as stadiums, station squares, airports, railway stations, and large public gatherings to increase the capacity of cellular connectivity.

Referring back to FIG. 1A, an exemplary system of the present disclosure comprises a BS 115 surrounded by mobile wireless nodes 105 participating in D-MIMO operation, forming a Mobile-Distributed Antenna Array (M-DAA) 120 and serving a group of UEs within a cellular area. Accordingly, the base station may be a cellular base station or part of a cellular base station such as a radio unit (RU) or a distributed unit (DU). In various embodiments, the operation of exemplary architecture is divided into two distinct phases, as previously discussed. In Phase 1, depicted in FIG. 1B, a BS 115 broadcasts data to the cooperating D-MIMO nodes 105, forming a downlink (DL) multiuser MIMO channel. FIG. 1A shows the handset UEs, and motorized drones and vehicles with transceivers acting as mobile wireless nodes 105. A second phase of communication (Phase 2) occurs between the BS 115 in cooperation with the D-MIMO nodes 105 to the UEs, forming a D-MIMO channel, functioning as a multi-user MIMO Broadcast Channel (BC) or a single-user MIMO channel based on the transmission scheme used to serve the UEs. The node selection or placement can be optimized based on ensuring good SNR links between the BS 115 to nodes and nodes 105 to UEs, such as by being uniformly distributed in a circular arrangement with a radius R, with the BS 115 at the center.

As such, Phase 1 is the initial phase during which the D-MIMO nodes 105 receive data from the BS 115, defining the capacity of the nodes 105 participating in the M-DAA 120. All nodes 105 in the M-DAA 120 receive the same data. It is anticipated that this will be a relatively high-capacity link due to the nodes' proximity to the BS 115, with LOS or non-LOS conditions where path loss is fairly low. The key constraint here is that the nodes 105 do not have the information to be transmitted in Phase 2 a priori and must obtain it from the BS 115. Once the information is received and decoded at each node 105, the BS 115 and D-MIMO nodes 105 encode, modulate, and precode the data based on the D-MIMO channel. Phase 1 follows a multi-user BC, except the BS 115 transmits the same data to all nodes 105. In Phase 2, the nodes 105 and BS 115 collaborate to coherently joint transmit to the serving UEs. This collaboration is key in maximizing the system's capacity by providing improved beamforming gain. Since the data on each transmitter for a specific MIMO layer is the same, there is no interference between transmitters in the same layer, but inter-layer interference persists. The layer here is defined as the independent data stream sent either in Phase 1 or Phase 2, where Phase 1 and Phase 2 share the same frequency band and each node 105 and BS 115 in the M-DAA 120 possesses complete channel knowledge (i.e., channel state information (CSI)) between itself and the served UEs and serves only one UE at a time.

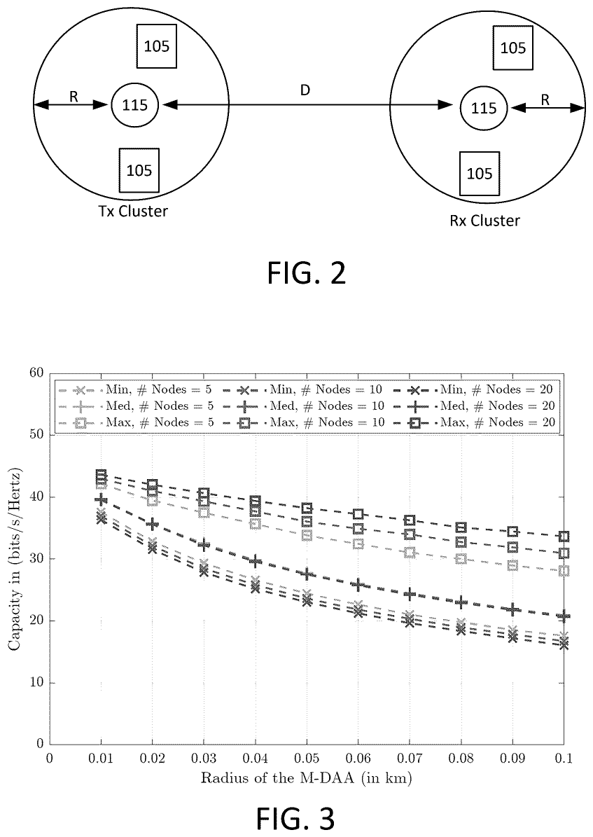

In certain embodiments, a vehicle mounted base station can serve user equipment (UE) within a mobile deployed cluster. Accordingly, the UEs may be associated with, for example, end-user radios, machine-type communications devices, or other vehicles. As a non-limiting guideline, each cluster may have up to 10 D-MIMO assisting nodes 105 within a radius (R) of 100 m. In this non-limiting example, the distance (D) between clusters may be on the order of 1 km, where each cluster is anchored with a terrestrial vehicle. All nodes, including the BS (e.g., gNB) are mobile and may be moving depending on the scenario. An illustration of the cluster-to-cluster architecture 200 is shown in FIG. 2. In order to support inter-cluster communications, in various embodiments, a data packet is communicated from the BS 115 (e.g., gNB) of one cluster to the BS 115 (e.g., gNB) of a second cluster (i.e., inter-cluster link), in which the inter-cluster link shares an access channel (frequency band of operation) with the intra-cluster communications. The BS 115 and assisting nodes 105 of a first transmitting cluster (the Tx cluster) collectively transmit information to the BS 115 and assisting nodes 105 of a second receiving cluster (the Rx cluster). The Tx cluster nodes and Rx cluster nodes form virtual antenna arrays on each end of the inter-cluster link, resulting in a distributed MIMO channel. Because the intra-cluster links are wireless, the end-to-end inter-cluster link comprised three component links: (1) Tx cluster broadcast channel: the BS-to-UE downlink is used to pre-distribute information among the nodes 105 of the virtual transmit array of the D-MIMO channel; (2) MD-MIMO channel: transmission from the transmit virtual array of the Tx cluster to the receive virtual array of the Rx cluster; and (3) Rx cluster multiple access channel (uplink): the UE-to-BS uplink is used to forward information received by the assisting nodes 105 of the virtual receive array to the Rx cluster base station 115. Alternative architectures for frequency assignment include intra-cluster links at a first frequency band of operation and inter-cluster links at a second frequency band of operation. Accordingly, clusters in the network may use a common frequency band of operation of intra-cluster links, or different cluster-specific bands. The intra- and inter-cluster links may operate in full or half duplex configurations, with options for frequency or time division duplex (FDD and TDD).

Challenges in the wireless architecture of the present disclosure include synchronization and ensuring that channel state information (CSI) is available at the D-MIMO nodes 105 and BS 115. Synchronization requires aligning both time references and carrier frequencies at the nodes 105 and BS 115. In current practice, BSs rely on the power-intensive Global Positioning System (GPS) for synchronization. However, this approach may be untenable due to the battery-operated nature of D-MIMO nodes 105 in certain embodiments and the fact that the nodes 105 might be in places where the GPS signal reception is weak. An alternative is wireless synchronization using a common beacon that transmits time and frequency synchronization signals among the M-DAA 120. This beacon can be either a separate node or the BS itself. Considerable theoretical and practical research has explored these techniques, achieving time accuracy in the picosecond range and frequency accuracy of less than 1 Hertz, approaching the precision of wired synchronization techniques. To ensure CSI is available at the nodes 105 and BS 115, the advantages of time division duplex (TDD) channel reciprocity can be leveraged. This involves UEs transmitting reverse-link pilot signals, enabling the D-MIMO nodes 105 and BS 115 to perform channel estimation (such as estimating full multiple-input multiple-output (MIMO) radio channel conditions based on a limited set of MIMO radio channel measurements for a target user equipment device), and compute the precoders for coherent transmission. In another embodiment, the BS 115 and D-MIMO nodes 105 transmit pilot signals, enabling the UEs to perform channel estimation. The UEs may transmit CSI information to the BS and D-MIMO nodes or compute precoder information for feedback to the BS and D-MIMO nodes. However, the mobility of the UE impacts the promised gains, with higher mobility the channel changes rapidly and the precoding weights computed based on the outdated channel will not result in coherent transmission. Thus, channel prediction algorithms may be used depending on the mobility of UEs. Channel prediction algorithms include classical algorithms (e.g., auto-regressive models and parametric models) and machine learning (ML) based methods. In one embodiment, a conventional linear estimation algorithm such as least squares (LS) or linear minimum mean square error (LMMSE) estimation is used to calculate initial estimates. Initial estimates are input into a ML prediction algorithm to obtain predicted channel estimates. Predicted estimates may include CSI for future time slots, CSI for additional frequency bands, or CSI for additional D-MIMO nodes. In this way, the BS and D-MIMO nodes transmit a reduced set of pilot signals compared with full channel estimation. In one embodiment, the channel prediction algorithm comprises a neural network. The weights of the neural network are trained during operation of the communication system. In such an embodiment, a portion of the weights of the neural network may be fixed and a second portion may be trained during operation, enabling high-speed applications such as communication systems. Accordingly, the following capacity analysis of the disclosed wireless D-MIMO architecture demonstrates a significant increase in system capacity based on realistic 3GPP channel models, even with the two-phase wireless operation without requiring changes in the network layout architecture.

### Phase 1 Capacity Analysis

Considering U nodes 105 in the M-DAA, with

$${N}_{t}^{BS}$$

transmit antennas at the BS 105 and

$${N}_{r}^{u}$$

receive antennas at the node 115, the channel between the BS 115 and the node 105 is represented as Hᵤ with size

$${N}_{r}^{u} \times {N}_{t}^{BS} .$$

The data at the BS 115 is encoded and split into Nₛ layers denoted as S, multiplied by the precoding matrix Fᵤ of size

$${N}_{t}^{BS} \times {N}_{s}$$

corresponding to each node and is transmitted by the BS 115. The received signal at the node u is

$${Y}_{u} = \sqrt{{G}_{u}} {H}_{u} {X}_{u} + \sqrt{{G}_{u}} {\sum }_{k = 1 , k \neq u}^{U} {H}_{u} {X}_{k} + {V}_{u} , \qquad ( 1 )$$

where the transmitted symbol vector from the u-th D-MIMO node is

$${X}_{u} = \sqrt{\frac{{E}_{u}}{{N}_{t}^{BS}}} {F}_{u} S .$$

### The

$${V}_{u} ∼ 𝒞𝒩 ( 0 , {σ}_{u}^{2} {I}_{{N}_{r}^{u}} )$$

represents the additive white Gaussian noise (AWGN) added at the receiver of the node. The entries of Hᵤ follow a complex Gaussian distribution [symbol] (0,1) with their amplitude following Rayleigh fading. Gᵤ denotes the large-scale path-loss gain experienced by every entry of the channel. Eᵤ corresponds to the transmitted energy per symbol allocated per node and is subject to a sum constraint,

$${\sum }_{u = 1}^{U} {E}_{u} = {E}_{s} .$$

### Expanding (1), we get

$${Y}_{u} = \sqrt{\frac{{G}_{u} {E}_{u}}{{N}_{t}^{BS}}} {H}_{u} {F}_{u} S + \sqrt{{G}_{u}} {\sum }_{k = 1 , k \neq u}^{U} \sqrt{\frac{{E}_{k}}{{N}_{t}^{BS}}} {H}_{u} {F}_{k} S + {V}_{u} . \qquad ( 2 )$$

The maximum number of data layers possible is equal to

$${N}_{s} = min ( {N}_{t}^{BS} , {N}_{r}^{u} ) .$$

Since the links between the BS and nodes have high SNR, it is assumed that there is no CSI at the BS and thus precoders are chosen as

$${F}_{u} = [ \begin{matrix}{I}_{{N}_{s} \times {N}_{s}} \\ {0}_{( {N}_{t}^{BS} - {N}_{s} ) \times {N}_{s}}\end{matrix} ] .$$

Further, the overhead due to the channel estimation and precoder computation at the BS is eliminated. The equation (2) thus can be written as

$${Y}_{u} = \sqrt{\frac{{G}_{u} {E}_{s}}{{N}_{s}}} {H}_{u} S + {V}_{u} .$$

The mutual information between the BS and the u^{th} node is I(Yᵤ, S)=H(Yᵤ)−H(Yᵤ|S), where

$$H ( {Y}_{u} ) = log \vert e π {\sum }_{{Y}_{u}} \vert and H ( {Y}_{u} \vert S ) = log \vert e π {σ}_{u}^{2} {I}_{{N}_{r}^{u}} \vert ,$$

and the co-variance of Yᵤ, i.e., Σ_{Y}_{ᵤ}, is

$${\sum }_{{Y}_{u}} E \{ {Y}_{u} {Y}_{u}^{H} \} = \frac{{G}_{u} {E}_{s}}{{N}_{s}} {H}_{u} {H}_{u}^{H} + {σ}_{{Y}_{u}}^{2} I . \qquad ( 3 )$$

Here, H(X) is defined as the entropy of X and

$${σ}_{u}^{2}$$

is the AWGN noise power at node u. Then, based on (3), the capacity of individual nodes 105 is

$$I ( {Y}_{u} , S ) = {log}_{2} \vert \frac{{E}_{s} {G}_{u}}{{N}_{s} {σ}_{{Y}_{u}}^{2}} {H}_{u} {H}_{u}^{H} + {I}_{{N}_{r}^{u}} \vert .$$

Since all the nodes must receive the same data, the capacity (in b/s/Hz) of Phase 1 with bandwidth B₁ will come down to the minimum capacity across all the receiving nodes, i.e.,

$${C}_{1} = {B}_{1} \times min [ I ( {Y}_{u} , S ) ] ,$$

and the system's capacity will depend on the channel Hᵤ between the BS 115 and the worst-case node. If some nodes 105 have low channel gain, those nodes will have less rate bottlenecking D-MIMO capacity.
Note: The determinant of a matrix, represented as |⋅|, where (⋅) represents any arbitrary matrix, is a scalar value that can be computed from its elements.

### Phase 2 Capacity Analysis

Given that each entity, i.e., each node 105 and the BS 115 of M-DAA 120, knows the channel between itself and the serving UE, coherent transmission is enabled by agreeing upon a common transmission time. The channel estimation will be specific to each entity of the M-DAA 120, and the precoders will eliminate inter-layer interference caused by the channel between them, thereby providing the necessary beamforming gain at the receiver. The number of data layers at each entity of the M-DAA, Nₛ, in S̅ is determined by the minimum number of antennas of the entities of the M-DAA 120 and serving UE, i.e.,

$${N}_{s} = min ( {N}_{t}^{BS} , {N}_{t}^{u} , {N}_{r}^{UE} ) .$$

Since the data S̅ at each entity of the M-DAA 120 is the same, each layer will have no interference from each transmitter. The channel between the BS and UE is represented by H̅_{BS} with size

$${N}_{r}^{UE} \times {N}_{t}^{BS} ,$$

and the node u and UE is given by H̅ᵤ with size

$${N}_{r}^{UE} \times {N}_{t}^{u} .$$

G̅ᵤ and G̅_{BS} are the large-scale path-loss gain experienced by every entry of the channel. Each node's precoder F̅ᵤ and the BS's precoder F̅_{BS} will have sizes of

$${N}_{t}^{u} \times {N}_{s} and {N}_{t}^{BS} \times {N}_{s} ,$$

respectively. Assuming the perfect CSI, the received signal at the UE is given by

$${\overline{Y}}_{UE} = {\sum }_{u = 1}^{U} \sqrt{{\overline{G}}_{u}} {\overline{H}}_{u} {\overline{X}}_{u} + \sqrt{{\overline{G}}_{BS}} {\overline{H}}_{BS} {\overline{X}}_{BS} + {V}_{UE} , \qquad ( 4 )$$

where the transmitted symbol vector corresponding to that node and BS are given by

$${X}_{u} = \sqrt{\frac{{E}_{u}}{{N}_{t}^{u}}} {\overline{F}}_{u} , \overline{S} , {\overline{X}}_{BS} = \sqrt{\frac{{E}_{BS}}{{N}_{t}^{BS}}} {\overline{F}}_{BS} \overline{S} . \qquad ( 5 )$$

Equation (4) can be expanded using Equation (5) giving

$${\overline{Y}}_{UE} = {\sum }_{u = 1}^{U} \sqrt{{\overline{G}}_{u}} {\overline{H}}_{u} \sqrt{\frac{{E}_{u}}{{N}_{t}^{u}}} {\overline{F}}_{u} , \overline{S} + \sqrt{{\overline{G}}_{BS}} {\overline{H}}_{BS} \sqrt{\frac{{E}_{BS}}{{N}_{t}^{BS}}} {\overline{F}}_{BS} \overline{S} + {V}_{UE} .$$

The mutual information between the M-DAA and the UE is

$$I ( {\overline{Y}}_{UE} , \overline{S} ) = H ( {\overline{Y}}_{UE} ) - H ( {\overline{Y}}_{UE} \vert \overline{S} ) , = {log}_{2} \vert e π {\sum }_{{\overline{Y}}_{UE}} \vert - {log}_{2} \vert e π {σ}_{UE}^{2} {I}_{{N}_{r}^{UE}} \vert ,$$

where the covariance matrix is

$${\sum }_{{\overline{Y}}_{UE}} = E \{ {\overline{Y}}_{UE} {\overline{Y}}_{UE}^{H} \} = {HFF}^{H} {H}^{H} + {σ}_{UE}^{2} {I}_{{N}_{r}^{UE}} ,$$

where,

$$E \{ {\overline{Y}}_{UE} {\overline{Y}}_{UE}^{H} \} = ( {\sum }_{u = 1}^{U} \sqrt{\frac{{\overline{G}}_{u} {\overline{E}}_{u}}{{N}_{t}^{u}}} {\overline{H}}_{u} {\overline{F}}_{u} + \sqrt{\frac{{\overline{G}}_{BS} {\overline{E}}_{BS}}{{N}_{t}^{BS}}} {\overline{H}}_{BS} {\overline{F}}_{BS} ) \times {( {\sum }_{u = 1}^{U} \sqrt{\frac{{\overline{G}}_{u} {\overline{E}}_{u}}{{N}_{t}^{u}}} {\overline{H}}_{u} {\overline{F}}_{u} + \sqrt{\frac{{\overline{G}}_{BS} {\overline{E}}_{BS}}{{N}_{t}^{BS}}} {\overline{H}}_{BS} {\overline{F}}_{BS} )}^{H} + {σ}_{UE}^{2} I .$$

Therefore, the capacity of Phase 2 reduces to

$${log}_{2} \vert \frac{1}{{σ}_{UE}^{2}} ( {\sum }_{u = 1}^{U} \sqrt{\frac{{\overline{G}}_{u} {\overline{E}}_{u}}{{N}_{t}^{u}}} {\overline{H}}_{u} {\overline{F}}_{u} + \sqrt{\frac{{\overline{G}}_{BS} {\overline{E}}_{BS}}{{N}_{t}^{BS}} {\overline{H}}_{BS} {\overline{F}}_{BS}} ) ( {\sum }_{u = 1}^{U} \sqrt{\frac{{\overline{G}}_{u} {\overline{E}}_{u}}{{N}_{t}^{u}}} {\overline{F}}_{u}^{H} {\overline{H}}_{u}^{H} + \sqrt{\frac{{\overline{G}}_{BS} {\overline{E}}_{BS}}{{N}_{t}^{BS}}} {\overline{F}}_{BS}^{H} {\overline{H}}_{BS}^{H} ) + I \vert .$$

Here, we opt for zero-forcing (ZF) precoders Fᵤ to eliminate the inter-layer interference. These precoders diagonalize the argument of determinant maximizing the capacity and are given by the pseudo-inverse of the entities' channels as

$${\overline{F}}_{BS} = {\overline{H}}_{BS}^{†} \& {\overline{F}}_{u} = {\overline{H}}_{u}^{†} .$$

The joint sum power constraints for the antennas on each node and BS are

$${\sum }_{i = 1}^{{N}_{t}^{u}} {p}_{u}^{i} \leq {P}_{u} and {\sum }_{i = 1}^{{N}_{t}^{BS}} {p}_{BS}^{i} \leq {P}_{BS} .$$

With proper normalization, the sum power constraints of nodes and BS are met, i.e.,

$$E \{ {X}_{u} {X}_{u}^{H} \} = \frac{{E}_{u}}{{N}_{t}^{u}} {I}_{{N}_{t}^{u}} \& E \{ {X}_{BS} {X}_{BS}^{H} \} = \frac{{E}_{BS}}{{N}_{t}^{BS}} {I}_{{N}_{t}^{BS}} . \qquad ( 6 )$$

The capacity can be further reduced to

$${\overline{N}}_{s} {log}_{2} ( \frac{1}{{σ}_{UE}^{2}} {( {\sum }_{u = 1}^{U} \sqrt{\frac{{\overline{G}}_{u} {\overline{E}}_{u}}{{N}_{t}^{u}}} + \sqrt{\frac{{\overline{G}}_{u} {\overline{E}}_{u}}{{N}_{t}^{u}}} )}^{2} + 1 ) .$$

This capacity expression indicates that each layer benefits from additional power with diversity, represented by the term

$${\sum }_{u = 1}^{U} \sqrt{\frac{{\overline{G}}_{u} {\overline{E}}_{u}}{{N}_{t}^{u}}} .$$

### Simulation Analysis

For simulation analysis, 3GPP channel models for large-scale fading are adopted due to their inclusion of 3D environmental modelling. Urban Micro (UMi) is selected for its relevance to real-world settings like urban areas or station squares with Non-Line-of-Sight (NLOS) settings in both phases. Path loss is determined based on antenna heights, carrier frequency, shadow fading, distances between BS 115 and nodes 105 in Phase 1, and distances between nodes 105 and BS 115 serving UEs in Phase 2.

First, the capacity of Phase 1 and Phase 2 are analyzed individually with different numbers of nodes, i.e., 5, 10, and 20. Then, the two phases are combined and the D-MIMO capacity plots are compared with the baseline (number of nodes=0), where the BS 115 directly communicates with the UE. 3GPP specifications define various power classes for UE (e.g., Vehicular, Handheld, High Power Non-Handheld, High-Speed Train Roof-Mounted UEs) that can be adopted for the node transmission power. All these users can be potential mobile nodes participating in D-MIMO operation. The node transmission power of 26 dBm was considered since this value was used for sidelink-UE and the base station transmission power of 33 dBm defined in Table 5.1.8 of the 3GPP TS 25.942 specifications.

For Phase 1 communications, FIG. 3 illustrates the minimum (lowest rate), maximum (highest rate), and median (where half of the nodes exceed the median rate) average rates of all nodes selected by the BS for D-MIMO operation versus the radius of M-DAA. The nodes (drone, vehicular, or other handset UE) are defined with heights ranging from 2.5 to 25 meters, uniformly selected within this range. They are uniformly distributed in a circular arrangement with a radius R, with the BS 115 at the center. Node rates are higher when closer to the BS 115, influenced by the non-linear nature of the path loss gain versus distance equation. Nodes 105 farther from the BS experience greater path loss compared to closer nodes, leading to lower median and minimum rates. The plots indicate that as the number of nodes increases, the maximum rate rises due to an increased likelihood of nodes being nearer to the BS 115, while the minimum rate decreases because of a higher probability of nodes being farther from the BS 115. This implies that for Phase 1 to involve all nodes 105 effectively in the D-MIMO phase, nodes should be uniformly distributed in a smaller geographic area within the circle (i.e., with a smaller radius) to ensure closer proximity to the BS 115 and higher capacity for all nodes. In other words, in certain embodiments, the nodes 105 should be chosen or placed around the BS 115 to ensure uniformly good SNR links among nodes in Phase 1.

The minimum rate node determines the capacity of Phase 1. Therefore, selecting a group of nodes with rates higher than the minimum rate node would increase the capacity of Phase 1. However, defining the minimum rate node as the capacity of Phase 1 allows all nodes to participate in the D-MIMO operation, enhancing the capacity of Phase 2. Selecting only a subset of nodes decreases the capacity of Phase 2.

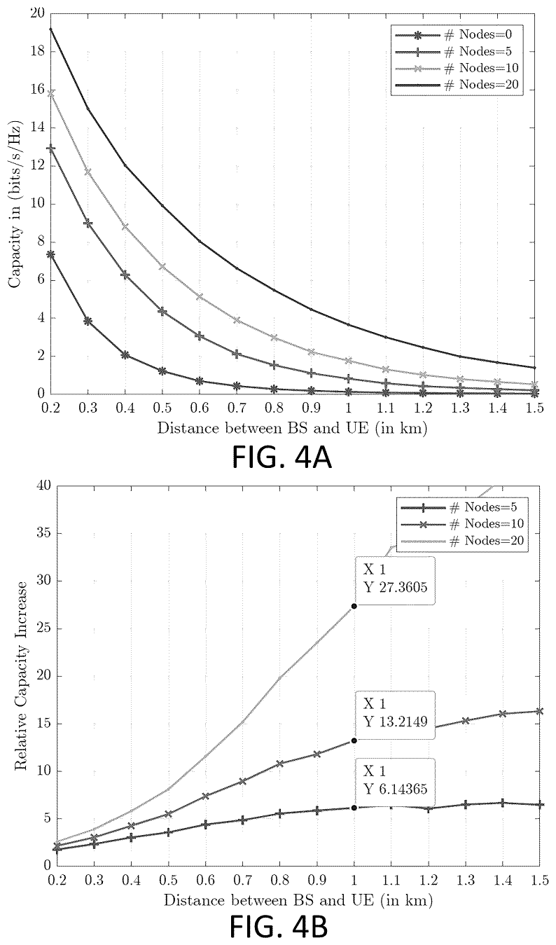

For phase 2 communications, FIGS. 4A and 4B illustrate the average capacity of Phase 2 and the relative capacity increase compared to the baseline (when ignoring the cost of the Phase 1 transmission). The capacity improved by a factor of 6.14 with 5 nodes, 13.21 with 10 nodes, and 27.36 with 20 nodes at a 1 km distance between the BS and UE. Using ZF precoders, pseudo-inverses of the channel matrices, ensured that inter-layer interference was eliminated, allowing the received signal from all transmitters to be coherently summed. Each layer will have an additional power gain of

$${\sum }_{u = 1}^{U} \sqrt{\frac{{\overline{G}}_{u} {\overline{E}}_{u}}{{N}_{t}^{u}}}$$

over the baseline. Additionally, as the distance between the M-DAA and UE increased, the relative capacity improvement over the baseline also increased. This also indicates that cell-edge users can significantly benefit from the disclosed approach. To elaborate further, the 5 nodes contributed 10 antennas to the M-DAA. Additionally, each node provided an extra power of 26 dBm. This configuration facilitated the transmission of the same data from both the nodes 105 and the BS 115 to the UE. Similarly, in scenarios involving 10 and 20 nodes, there were 20 and 40 more antennas respectively compared to the baseline, along with the same 26 dBm additional power per node.

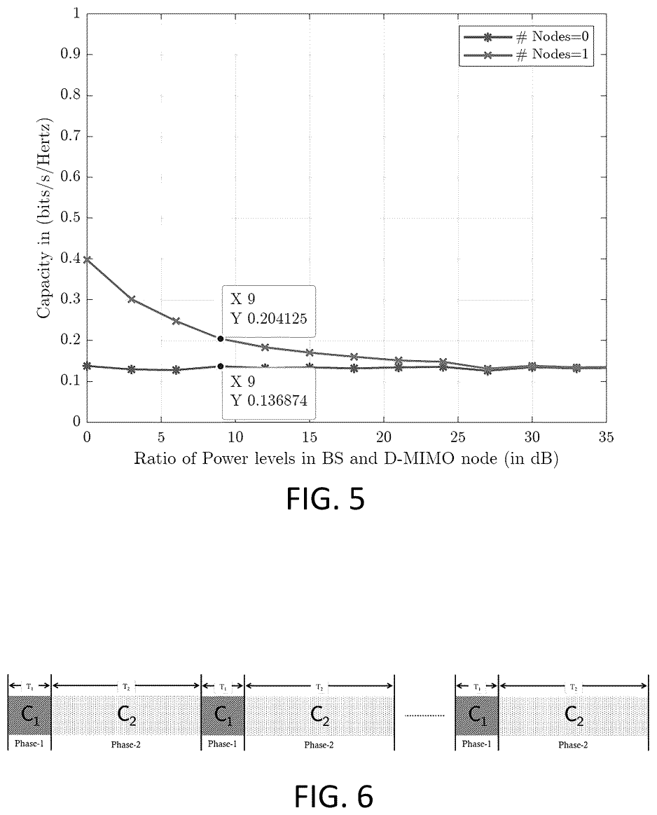

The contribution of a node's capacity concerning its transmission power level compared to the BS 115 in Phase 2 was explored in FIG. 5. Here, the figure shows the capacity with and without one node versus the node's transmission power level with UE placed at 1 km. The plot depicts that when the node's transmission power is below 9 dB compared to the BS power, the capacity contribution from the D-MIMO node is minimal. Thus, the node's transmission power plays a crucial role in defining the capacity of Phase 2.

Since D-MIMO operates in two phases, two time slots are required instead of one. FIG. 6 illustrates the timing diagram of the system operation. In this diagram, T₁ represents the time required for the BS to transmit its information bits to nodes at its maximum rate C₁ (i.e., the capacity of Phase 1). The time T₂ corresponds to the duration it takes for the nodes and BS to transmit all their information bits to the UE with their maximum rate C₂ (i.e., the capacity of Phase 2). After Phase 1 transmission, the same information bits C₁×T₁ (bits) are present at all the nodes and the BS. Now, in Phase 2, with its maximum rate C₂ (bits/s/Hz) through coherent transmission, to transfer the C₁×T₁ bits, the required time T₂ is

$${T}_{2} = \frac{{C}_{1} \times {T}_{1}}{{C}_{2}} .$$

Therefore, T₂ is determined by extracting C₁ and C₂ from the simulations assuming T₁=1 second. Consequently, a fair comparison can now be made between the D-MIMO and the baseline. The baseline, augmented with time correction, will include an additional time T₂ for information transfer (i.e., baseline with time correction C_{B}×(1+T₂)), where C_{B}=C₂ when the number of nodes equals 0. The present disclosure is not limited to adapting time resources. In another example, frequency resources or time/frequency (e.g., resource block allocations) may be adapted between the transmission phases. The allocated resources for D-MIMO transmission may be multiplexed with regular downlink or uplink traffic.

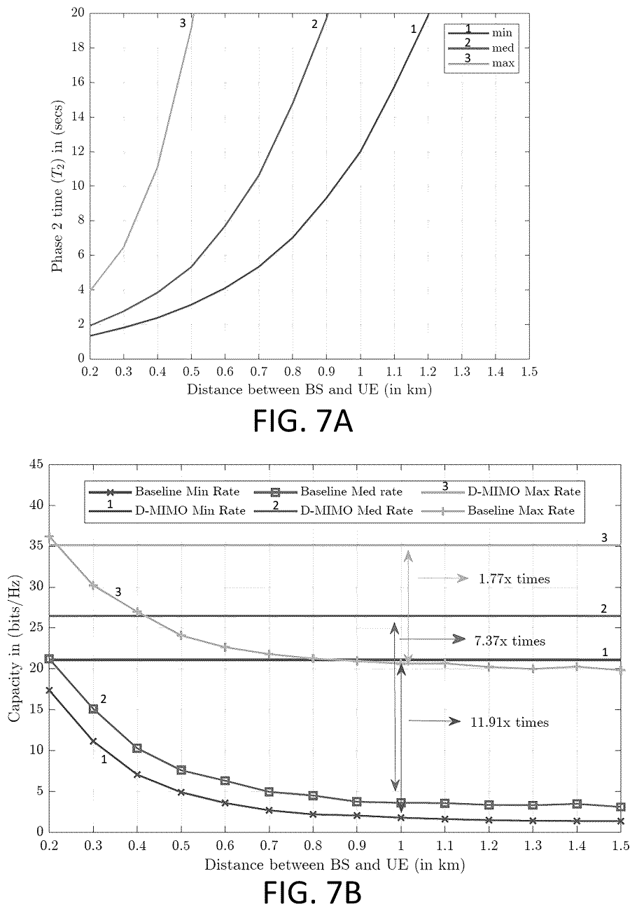

Next, FIGS. 7A-7B illustrate the D-MIMO Capacity compared to baseline (with two-time slots) under UMi path-loss settings. In particular, FIG. 7B illustrates the transfer of information bits (bits/Hz) from M-DAA to the UE in two time slots, one with a duration of T₁=1 second, and the other with a duration of T₂ seconds, as depicted in FIG. 7A. The flat curves represent the transfer of information bits in Phase 1 (C₁×T₁), which is the same as in Phase 2 (C₂×T₂), indicating the capacity of the D-MIMO system. The number of nodes considered is 10. Considering that the minimum rate defines the Phase 1 capacity, all nodes in the M-DAA operate during Phase 2. Consequently, the capacity of Phase 2 is high, requiring less time T₂ to transfer the information bits. However, when the median rate is used for Phase 1 capacity, only half of the nodes participate in Phase 2. In the scenario where the maximum rate is used for Phase 1, only the node with the maximum rate takes part in Phase 2. Hence, we observe a distinction in the duration of the D-MIMO channel, longer for the maximum rate, followed by the medium rate and then the minimum rate, as depicted in FIG. 7A. The largest gains over the baseline, achieved with time correction, are observed in the minimum-rate nodes, followed by the median-rate nodes. Conversely, the maximum-rate nodes exhibit the smallest gains. Specifically, the improvement values at a distance of 1 km are depicted in the plot, indicating enhancements of 11.91, 7.37, and 1.77 times, respectively. In terms of D-MIMO capacity, the maximum rate boasts the highest capacity, followed by medium and minimum rates. Thus, the plots indicate despite the two-phase operation, the capacity of D-MIMO is greater than the baseline with time correction. The plots also suggest that having at least one node with two-phase operation improves the total capacity of the system. Additionally, the improvements over the baseline increase as the distance between the BS and UE increases.

As shown, the capacity analysis of an exemplary wireless D-MIMO architecture demonstrates a significant increase in system capacity based on realistic 3GPP channel models, even with the two-phase wireless operation without requiring changes in the network layout architecture. The results also indicate a greater relative capacity increase for UEs located farther from the BS compared to the baseline. Additionally, the disclosed architecture ensures compatibility with current cellular systems and enables the reuse of existing infrastructure, thereby optimizing resource utilization. In various embodiments, multiple users may be served by scheduling through single-user MIMO or multi-user MIMO operations. Further, different architectures involving coherent and non-coherent joint transmission schemes including error rate analysis and system design with protocols and various realistic channel models such as 3GPP and air-to-ground (A2G) may be deployed. Also, in various embodiments, the placement or selection of nodes 105 around the BS 115 may be optimized based on the surrounding environment to maintain good SNR links at all nodes. The disclosure also supports uplink transmission from a user equipment device to a base station node via a set of assisting mobile devices.

According to another embodiment of the invention, D-MIMO transmission is performed for the uplink. In a Phase 1, the UE transmits information to D-MIMO nodes. In a Phase 2, the UE and the D-MIMO nodes precode the information and jointly transmit to the BS. According to another embodiment of the invention, D-MIMO reception is performed for the uplink. In a Phase 1, the UE transmits information to the BS and D-MIMO nodes. The BS and D-MIMO form a receive M-DAA for reception of the UE transmission. In a Phase 2, the D-MIMO transmit information about the received signal to the BS. The BS jointly processes the signal received from the UE and the information provided by the D-MIMO nodes to decode the UE transmission. According to another embodiment of the invention, D-MIMO reception is performed for the downlink. In a Phase 1, the BS transmits information to the D-MIMO nodes and the UE. The UE and D-MIMO nodes form a receive M-DAA for reception of the BS transmission. In a Phase 2, the D-MIMO nodes transmit information about the received signal to the UE. The UE jointly processes the signal received from the BS and the information provided by the D-MIMO nodes to decode the BS transmission. In this way the capacity and range of downlink and uplink data transmission are increased. In these embodiments, the D-MIMO nodes may comprise assisting mobile devices such as other UEs.

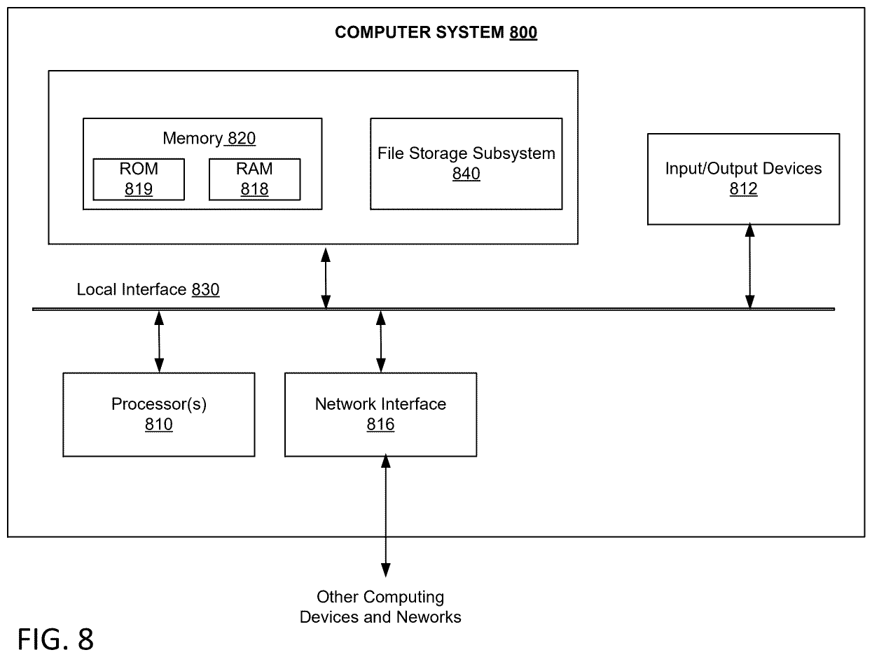

FIG. 8 depicts a schematic block diagram of a computing device or system 800 that can be used to implement various embodiments of the present disclosure, such as node 105, base station 115, or UE. An exemplary computing device 800 includes at least one processor circuit, for example, having a processor (CPU) 810 and a memory 820, both of which are coupled to a local interface 830, and one or more input and output (I/O) devices 812. The local interface 830 may comprise, for example, a data bus with an accompanying address/control bus or other bus structure as can be appreciated. The CPU 810 can perform various operations described herein.

Stored in the memory 820 are both data and several components that are executable by the processor 810. Memory 820 include one or more physical memory devices such as, for example, a local memory and one or more file storage subsystems 840. Local memory refers to random access memory (RAM) 818, read only memory (ROM) 819, or other memory device(s) generally used during actual execution of the program code. Storage subsystems 840 may be implemented as a hard disk drive (HDD), solid state drive (SSD), or other persistent data storage device. Computing system 800 may also include one or more cache memories (not shown) that provide temporary storage of at least some program code in order to reduce the number of times program code must be retrieved from storage device during execution.

Stored in the memory 820 and executable by the processor 810 are mobile distributed MIMO (MD-MIMO) routines, such as Phase 1 and Phase 2 communication schemes and related D-MIMO technologies, as described herein and possibly other related software or code. Also stored in the memory 820 may be a data store and other data. In addition, an operating system may be stored in the memory 820 and executable by the processor 810. The I/O devices 812 may include input devices, for example but not limited to, a keyboard (physical or touchscreen), mouse, communication adapters and/or transceivers, etc. Furthermore, the I/O devices 812 may also include output devices, for example but not limited to, a printer, display, etc.

A network adapter or interface 816 may also be coupled to computing system 800 to enable computing system to become coupled to other systems, base stations, computer systems, and/or remote storage devices through intervening private or public communication or computing networks. Modems, cable modems, Ethernet cards, and wireless transceivers are examples of different types of network adapter that may be used with computing system 800.

Certain embodiments of the present disclosure can be implemented in hardware, software, firmware, or a combination thereof. If implemented in software, mobile distributed MIMO (MD-MIMO) logic or functionality are implemented in software or firmware that is stored in computer-readable medium (e.g., a memory) and that is executed by a suitable instruction execution system. If implemented in hardware mobile distributed MIMO (MD-MIMO) logic or functionality can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette or drive (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical).

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A communication system comprising:
a base station node; and
a plurality of assisting mobile nodes;
wherein the plurality of assisting mobile nodes are in wireless communications with the base station node,
wherein in a downlink transmission of data from the base station node to a user equipment device, the base station node is configured to transmit data to the plurality of assisting mobile nodes, the base station node and the plurality of assisting nodes are configured to perform precoding signal processing on the data, and the base station node and the plurality of assisting nodes are configured to transmit the precoded data to the user equipment device.

2. The communication system of claim 1, wherein the plurality of assisting mobile nodes include a mobile device carried by people or deployed on a motorized vehicle.

3. The communication system of claim 2, wherein the motorized vehicle comprises an unmanned aerial vehicle.

4. The communication system of claim 1, wherein a frequency band used in transmission of the data from the base station node to the plurality of assisting mobile nodes is the same as the frequency band used in transmission of the precoded data to the user equipment device.

5. The communication system of claim 1, wherein the base station node comprises a cellular base station or part of a cellular base station.

6. The communication system of claim 1, wherein the base station node comprises a vehicle mounted base station.

7. The communication system of claim 1, wherein the plurality of assisting mobile nodes are associated with a source base station node.

8. A communication method comprising:
determining a plurality of assisting mobile nodes around a base station node within a predefined radius, wherein the plurality of assisting mobile nodes are in wireless communications with the base station node; and
transmitting data from the base station node to a user equipment device over a distributed multiple-input multiple output channel by:
transmitting, by the base station node, the data to the plurality of assisting mobile nodes;
performing, by the base station node and the plurality of assisting nodes, precoding signal processing on the data; and
transmitting, by the base station node and the plurality of assisting nodes, the precoded data to the user equipment device.

9. The communication method of claim 8, wherein the plurality of assisting mobile devices include a mobile device carried by people or deployed on a motorized vehicle.

10. The communication method of claim 9, wherein the motorized vehicle comprises an unmanned aerial vehicle.

11. The communication method of claim 10, further comprising signaling, by the base station node, placement information to the unmanned aerial vehicle.

12. The communication method of claim 8, wherein a frequency band used in transmission of the data from the base station node to the plurality of assisting mobile nodes is the same as the frequency band used in transmission of the precoded data to the user equipment device.

13. The communication method of claim 8, wherein the base station node comprises a cellular base station or part of a cellular base station.

14. The communication method of claim 8, wherein the base station node comprises a vehicle mounted base station.

15. The communication method of claim 8, wherein the plurality of assisting mobile nodes are associated with the base station node.

16. The communication method of claim 8, wherein the user equipment device is located outside a target coverage area of the base station node.

17. The communication method of claim 8, further comprising estimating full multiple-input multiple-output (MIMO) radio channel conditions based on a limited set of MIMO radio channel measurements for a target user equipment device.

18. A non-transitory computer readable medium comprising machine readable instructions that, when executed by a processor of a computing device, cause the computing device to at least:
receive data from a base station node that is in wireless communication with the computing device, wherein the data is designated for a user equipment device;
performing precoding signal processing on the data; and
transmitting the precoded data to the user equipment device.

19. The non-transitory computer readable medium of claim 18, wherein the computing device is distributed around the base station node within a target coverage area, wherein the user equipment device is located outside the target coverage area of the base station node.

20. The non-transitory computer readable medium of claim 18, wherein a plurality of assisting mobile nodes are positioned around the base station node within a predefined radius, wherein the plurality of assisting mobile nodes include the computing device.
